(19) United States
(12) Patent Application Publication
(10) Pub. No.: US 2005/0262269 A1
(43) Pub. Date: Nov. 24, 2005

(54) System and method for information handling system PCI express advanced switching

(76) Inventor: Jimmy D. Pike, Georgetown, TX (US)

Correspondence Address: HAMILTON & TERRILE, LLP, P.O. BOX 203518, AUSTIN, TX, 78720, US

(21) Appl. No.: 10/850,248

(22) Filed: May 20, 2004

(51) Int. Cl. G06F 3/00

(52) U.S. Cl. 710/1; 710/313

(57) ABSTRACT

Plural processing subsystems of an information handling system, such as plural blades of a blade server, communicate through a base protocol, such as PCI Express, to a peripheral communication device with each processing subsystem interfaced through a port of the peripheral communication device. An encapsulation module of the peripheral communication device encapsulates the base protocol in an advanced switching packet, such as a packet formed with the PCI Express Advanced Switching protocol. A routing module of the peripheral communication device routes the packets through a bus, such as a blade server backplane bus, for use of the information by a selected peripheral. Peripherals communicate with selected processing subsystems by sending advanced switching packets to the routing module for the encapsulation module to extract the peripheral information from the packets and send the peripheral information to the port associated with the selected processing subsystem.

### BACKGROUND OF THE INVENTION

1. Field of the Invention

The present invention relates in general to the field of information handling system component communication, and more particularly to a system and method for an information handling system PCI Express Advanced Switching.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include a number of components and peripherals that communicate or otherwise process information. Typically, information handling systems communicate between such components and peripherals through a backplane or bus using standardized protocols, such as the Peripheral Component Interconnect (“PCI”) and PCI Express protocols. For instance, portable information handling systems often include a PCI slot that accepts a peripheral device for use with the information handling system, such as a wireless networking card. Generally communication by the PCI and PCI Express protocols is performed in a relatively simple manner with information transferred relatively directly between components and peripherals. For example, PCI Express uses tree type addressing that allows transfer of information along a branch of a tree but that does not support transfer of information from one branch of a tree through a root to another branch of the tree. More complex communication protocols generally support transfer of information from one branch to another by formatting the information into packets that include header information for switching and routing the packets.

In order to improve the flexibility of the PCI Express protocol, the information handling system industry has cooperated to formulate the PCI Express Advanced Switch (AS) protocol. The AS protocol encapsulates information from a base protocol into a PCI Express AS packet that supports routing and switching of the information. Encapsulation of a base packet generally involves the addition of control and routing information in a packet header defined by the AS specification through which information in the PCI Express and other protocols can be “tunneled.” Implementation of the PCI Express Advanced Switching protocol in an information handling system is usually accomplished with discrete devices that add AS encapsulation to a PCI Express packet associated with a component or peripheral so that the PCI Express packet may be communicated through the backplane network fabric of the information handling system. For instance, information associated with a PCI Express device is communicated to an Advanced Switching bridge for encapsulation in a packet, routed through the backplane network to a second Advanced Switching bridge for extraction of the information from the packet, and communicated to the north bridge of an information handling system processing component associated with the second AS bridge for appropriate processing. The use of discrete devices for AS encapsulation increases the complexity of building and configuring an information handling system since a discrete device generally is used for each component or peripheral that uses the encapsulated protocol, such as PCI Express.

### SUMMARY OF THE INVENTION

Therefore a need has arisen for a system and method which simplifies implementation of PCI Express Advanced Switching in an information handling system having plural interfaced processing subsystems.

In accordance with the present invention, a system and method are provided which substantially reduce the disadvantages and problems associated with previous methods and systems for implementation of PCI Express Advanced Switching in an information handling system. A peripheral communication device receives peripheral information in a base protocol from plural processing subsystems, each processing subsystem communicating to one of plural ports of the peripheral communication device. The peripheral communication device encapsulates the peripheral information in advanced switching packets and routes the packets to selected peripheral devices.

More specifically, a blade server information handling system having plural blade processing subsystems interacts with one or more peripherals by routing peripheral information through a peripheral communication device interfaced with each processing subsystem. Peripheral information is communicated from each processing subsystem in a base protocol, such as PCI Express, to a port of the peripheral communication device that is assigned to the processing subsystem. An encapsulation module of the peripheral communication device encapsulates the peripheral information into PCI Express Advanced Switching packets by using header information associated with the port that receives the peripheral information. A routing module of the peripheral communication device routes the peripheral information to a selected peripheral device through a backplane bus of the information handling system. Information communicated from peripherals to processing subsystems through the backplane bus are received by the routing module and provided to the encapsulation module for extraction of the peripheral information from the PCI Express AS packet. Extracted peripheral information is communicated in the base protocol to the port of the peripheral communication device that is associated with a selected processing subsystem identified by the advanced switching packet.

The present invention provides a number of important technical advantages. One example of an important technical advantage is that encapsulation, routing and switching of information associated with plural processing subsystems of an information handling system are managed through plural ports of a single device. The use of a single device simplifies information handling system design and manufacture for systems having multiple processing components and multiple peripherals, such as blade servers. For instance, interfacing each blade of a blade server with a port of the peripheral communication device supports communication of information from a selected blade identified by AS packet information with a selected peripheral through a backplane by the PCI Express AS protocol. In this manner, individual blades need not have individual PCI Express Advanced Switching encapsulation hardware, relying instead on centralized encapsulation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having plural processing subsystems and a centralized peripheral communication device for encapsulation and routing of peripheral information in the PCI Express Advanced Switching protocol; and

FIG. 2 depicts a block diagram of distributed PCI Express Advanced Switching peripheral communication devices.

### DETAILED DESCRIPTION

Interfacing plural information handling system processing subsystems through a base protocol with a peripheral communication device allows centralized encapsulation and routing of peripheral information in an advanced switching protocol to simplify the design and manufacture of complex information handling systems, such as blade servers. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

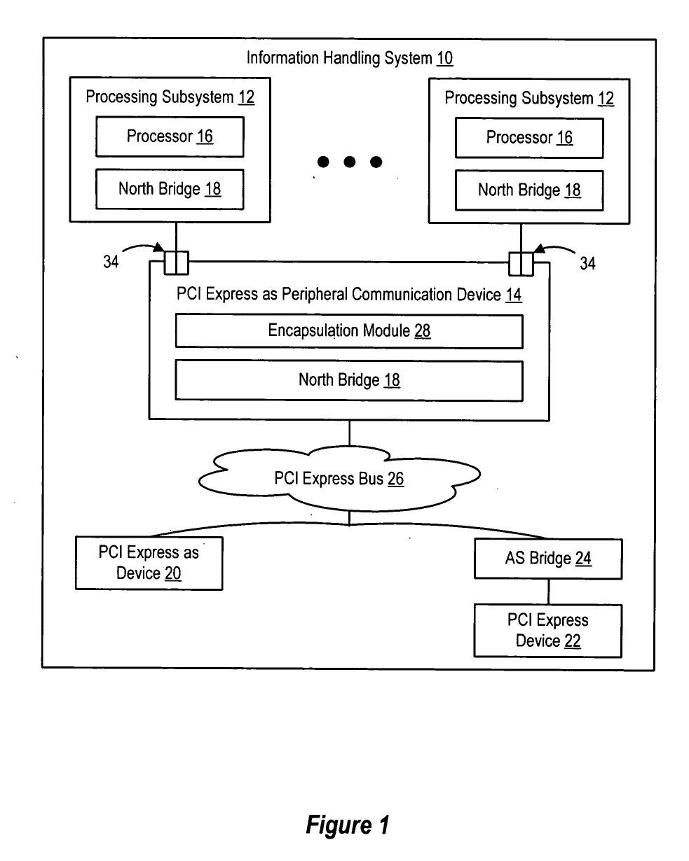

Referring now to FIG. 1, a block diagram depicts an information handling system 10 having plural processing subsystems 12 and a centralized peripheral communication device 14 for encapsulation and routing of peripheral information in the PCI Express Advanced Switching protocol. For instance, information handling system 10 is a blade server having plural processing subsystem blades 12 that process network information. Processing subsystems 12 include a processor 16 and north bridge 18 that generate information for communication to peripheral devices using a base protocol, such as PCI Express, and include other components to aid in processing of information, such as memory and firmware. Peripheral devices of information handling system 10 include PCI Express AS devices 20 that communicate directly over a PCI Express compatible backplane bus 26 and PCI Express devices 22 that have an associated advanced switching bridge 24 to encapsulate PCI Express information in the PCI Express AS protocol for communication over backplane bus 26. Peripheral information routes between selected processing subsystems 12 and selected devices 20 or 22 on backplane bus 26 with addressing information included in PCI Express Advanced Switching packet headers.

PCI Express Advanced Switching peripheral communication device 14 supports communication between selected processing subsystems 12 and selected peripheral devices 20 or 22 with an encapsulation module 30 and a routing module 32 disposed in a single housing. Encapsulation module 30 accepts peripheral information from a port 34 associated with a processing subsystem 12 and encapsulates the peripheral information in packets using the PCI Express AS protocol with the header information associating the peripheral information to the processing subsystem 12 by the receiving port 34. Encapsulated peripheral information is routed to peripheral devices by routing module 30. Information communicated from peripheral devices to a selected processing subsystem 12 through backplane bus 26 is routed with the PCI Express AS protocol through routing module 30 to encapsulation module 28 for the extraction of the peripheral information from the routing packet. Encapsulation module 28 directs the peripheral information to the selected port 34 based on the packet header information so that the peripheral information is communicated to the selected processing subsystem 12. Encapsulation module 28 encapsulates and extracts peripheral information associated with plural processing subsystems 12 thereby reducing the use of a separate advanced switching bridge for each processing subsystem.

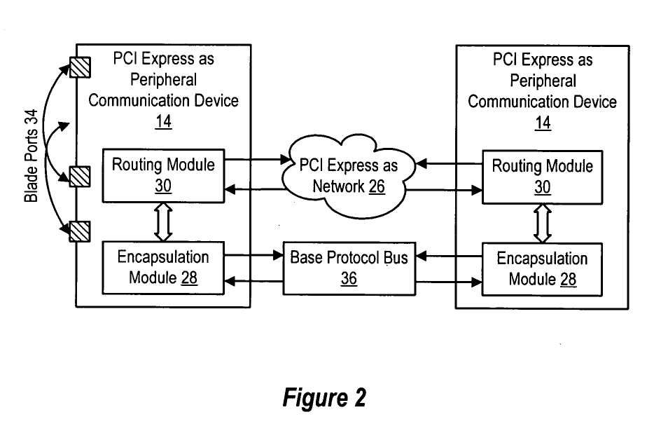

Referring now to FIG. 2, a block diagram depicts distributed PCI Express Advanced Switching peripheral communication devices 14 to illustrate an example of an advantage of centrally packetized peripheral information. First and second peripheral communication devices 14 route information between plural processing subsystems and plural peripheral devices through a PCI Express AS compatible network 26. Encapsulation module 28 communicates base protocol information through blade ports 34, which interface with blades of a blade server, and through a base protocol bus 36 that, for instance, directly interfaces with PCI Express devices. Any number of PCI Express AS peripheral communication devices 14 may interact to route peripheral information between selected processing subsystems and peripherals, thus supporting an information handling system scalable in the use of peripherals, such as with blade servers that use a relatively small number of peripherals for managing interconnected information handling systems.

Although the present invention has been described in detail, it should be understood that various changes, substitutions and alterations can be made hereto without departing from the spirit and scope of the invention as defined by the appended claims.

1. An information handling system comprising:
plural processing subsystems, each processing subsystem having processing components operable to process information associated with one or more peripherals, the peripheral information having a base protocol;
one or more peripherals operable to interact with the processing subsystem through the base protocol;
a backplane bus interfacing with the peripherals and operable to communicate peripheral information with an advanced switching protocol; and
a peripheral communication device interfaced with the backplane bus and each of the processing subsystems, the peripheral communication device operable to encapsulate into the advanced switching protocol the peripheral information received from the processing subsystems in the base protocol and to route the peripheral information to a selected peripheral through the backplane bus in the advanced switching protocol.

2. The information handling system of claim 2 wherein the peripheral communication device is further operable to remove peripheral information received from the backplane bus in the advanced switching protocol for communication to a selected processing subsystem in the base protocol.

3. The information handling system of claim 2 wherein the advanced switching protocol is the PCI Express Advanced Switching protocol.

4. The information handling system of claim 3 wherein the base protocol comprises PCI Express.

5. The information handling system of claim 4 wherein one or more peripherals comprise a PCI Express Advanced Switching compliant peripheral.

6. The information handling system of claim 4 wherein one or more peripherals comprise a PCI Express compliant peripheral, the information handling system further comprising an advanced switching encapsulation device disposed between the PCI Express compliant peripheral and the peripheral communication device, the encapsulation device operable to interface the peripheral with the peripheral communication device using the advanced switching protocol.

7. The information handling system of claim 4 wherein each processing subsystem is a blade of a blade server.

8. The information handling system of claim 4 further comprising a second peripheral communication device interfaced with the backplane bus and operable to communicate peripheral information with the first peripheral communicate device in the advanced switching protocol.

9. A peripheral communication device comprising:
plural base protocol ports, each port operable to communicate information with a component through a base protocol;
an encapsulation module interfaced with the base protocol ports, the encapsulation module operable to encapsulate information received from the base protocol ports into packets having an advanced switching protocol; and
a routing module interfaced with the encapsulation module and operable to communicate the information to a selected peripheral in the advanced switching protocol through a bus.

10. The peripheral communication device of claim 9 wherein the routing module is further operable to receive information associated with a selected component from a peripheral through the bus in the advanced switching protocol and the encapsulation module is further operable to communicate the information in the base protocol to a base protocol port associated with the component.

11. The peripheral communication device of claim 9 wherein the advanced switching protocol comprises the PCI Express Advanced Switching protocol.

12. The peripheral communication device of claim 11 wherein the base protocol comprises the PCI Express protocol.

13. The peripheral communication device of claim 11 wherein the component comprises a processing subsystem bridge.

14. The peripheral communication device of claim 13 wherein the processing subsystem comprises a server subsystem and the bus comprises a blade server backplane bus.

15. A method for communicating information between plural processing subsystems and one or more peripherals, the method comprising:
generating information for a peripheral at the processing subsystems;
communicating the information in a base protocol to ports of a peripheral communication device, each port associated with one of the processing subsystems;
encapsulating the information in advanced switching protocol packets at the peripheral communication device, the packets having routing information based on the port associated with the information; and
routing the advanced switching protocol packets to selected of the peripherals over a bus with the advanced switching protocol.

16. The method of claim 15 wherein the advanced switching protocol comprises the PCI Express Advanced Switching protocol.

17. The method of claim 16 wherein generating information further comprises generating information with information handling system blades of a blade information handling system server.

18. The method of claim 17 wherein routing the advanced switching protocol packets further comprises routing the packets through a blade information handling system server backplane bus.

19. The method of claim 16 further comprising:
routing advanced switching protocol packets having peripheral information from a peripheral through the bus to the peripheral communication device for communication to a selected processing subsystem;
extracting the peripheral information from the advanced switching packets at the peripheral communication device; and
communicating the extracted information in the base protocol to the port associated with the selected processing subsystem.

20. The method of claim 19 wherein the base protocol comprises PCI Express.

21. The method of claim 19 further comprising:
communicating the peripheral information from the processing subsystem through the peripheral communication device to a second processing subsystem in the base protocol; and
communicating the peripheral information from the peripheral through the peripheral communication device to a second peripheral in the advanced switching protocol.
